(19) United States
(12) Patent Application Publication
(10) Pub. No.: US 2023/0231143 A1
(43) Pub. Date: Jul. 20, 2023

(54) ANODELESS ALL-SOLID-STATE BATTERY COMPRISING PROTECTIVE LAYER AND MANUFACTURING METHOD THEREOF

(71) Applicants: Hyundai Motor Company, Seoul (KR); Kia Corporation, Seoul (KR); Industry-University Cooperation Foundation Hanyang University, Seoul (KR)

(72) Inventors: Jae Min Lim, Suwon (KR); Soon Chul Byun, Yongin (KR); Yoon Seok Jung, Seoul (KR); Seunggoo Jun, Pyeongtaek (KR)

(21) Appl. No.: 18/078,861

(22) Filed: Dec. 9, 2022

(30) Foreign Application Priority Data
Jan. 18, 2022 (KR) 10-2022-0007285

(51) Int. Cl. H01M 4/62; H01M 4/04; H01M 10/0525

(52) U.S. Cl. CPC H01M 4/628; H01M 4/0407; H01M 10/0525

(57) ABSTRACT

Disclosed are an anodeless all-solid-state battery including a protective layer formed on an anode current collector and a method for manufacturing the same. The anodeless all-solid-state battery may be capable of inhibiting the growth of lithium dendrites formed therein.

### CROSS-REFERENCE TO RELATED APPLICATION

This application claims under 35 U.S.C. §119(a) the benefit of priority to Korean Patent Application No. 10-2022-0007285 filed on Jan. 18, 2022, the entire contents of which are incorporated herein by reference.

### TECHNICAL FIELD

The present disclosure relates to an anodeless all-solid-state battery capable of inhibiting the growth of lithium dendrites by including a protective layer formed on an anode current collector and a method for manufacturing the same.

### BACKGROUND

An all-solid-state battery includes a three-layer laminate including a cathode layer bonded to a cathode current collector, an anode layer bonded to an anode current collector, and a solid electrolyte layer disposed between the cathode layer and the anode layer. In general, the anode layer of the all-solid-state battery contains an active material such as graphite, and a solid electrolyte. The solid electrolyte is involved in the movement of lithium ions within the anode layer. However, the solid electrolyte has a greater specific gravity than an electrolyte of a lithium ion battery, and due to its presence, the ratio of an active material in the anode layer is reduced so that the actual energy density of the all-solid-state battery is less than that of the lithium ion battery.

Recently, research on an anodeless all-solid-state battery in which the anode layer is removed and lithium ions, which move toward the anode current collector, are directly precipitated on the anode current collector during charging, is being conducted. However, in the anodeless all-solid-state battery, lithium is difficult to uniformly precipitate, and dendrite lithium grows and passes through the solid electrolyte layer so that there is a possibility of causing a short circuit and performance deterioration of the battery.

A conventional lithium ion battery includes a protective layer which suppresses the growth of lithium dendrites and is formed on lithium metal or an anode current collector that is an anode layer. In the lithium ion battery, a liquid electrolyte may penetrate the protective layer to form a movement path of lithium ions to lithium metal or the anode current collector. Accordingly, lithium ions transferred from the cathode layer may be electrodeposited as lithium metal on the surface of the lithium metal or the anode current collector.

However, an anodeless all-solid-state battery uses a solid electrolyte unlike the lithium ion battery. Thus, when a protective layer is applied thereto, lithium ions that have passed through the solid electrolyte cannot pass through the protective layer which has no ion transfer path or has difficulty in transferring ions, so that the lithium ions cannot be electrodeposited as lithium metal on the anode current collector.

### SUMMARY

In preferred aspects, provided are an anodeless all-solid-state battery including a protective layer capable of transferring lithium ions and a method for manufacturing the same. The protective layer may have excellent physical properties and inhibit the growth of lithium dendrites.

Further, provided is an anodeless all-solid-state battery capable of inducing lithium metal to be electrodeposited between a protective layer and an anode current collector, not between a protective layer and a solid electrolyte layer, and a method for manufacturing the same.

A term “all-solid-state battery” as used herein refers to a rechargeable secondary battery that includes an electrolyte in a solid state, e.g., gel or polymer (cured), which may include an ionomer and other electrolytic components for transferring ions between the electrodes of the battery.

A term “anode-free lithium ion battery,” “anodeless lithium ion battery,” “anode-free battery,” or “anodeless battery” as used herein refers to a lithium ion battery including a bare current collector at its anode side, which is in contrast to a lithium ion battery that uses lithium metal as an anode. The anode-free lithium ion battery includes a current collector including anode active material, which may be bonded, coated, attached, sprayed, painted or applied on the surface of the current collector. Preferably, the anode active material is coated on the surface of the current collector and formed as a layer or film.

The objects of the present disclosure are not limited to the objects mentioned above. The objects of the present disclosure will become more apparent from the following description, and will be realized by means described in the claims and combinations thereof.

In an aspect, provided is an anodeless all-solid-state battery including an anode current collector, a protective layer disposed on the anode current collector, a solid electrolyte layer disposed on the protective layer, and a cathode layer disposed on the solid electrolyte layer. The protective layer may include a first material having electrical conductivity and a second material that forms a solid solution with lithium. In particular, the protective layer may include a first layer on the side of the anode current collector and a second layer on the side of the solid electrolyte layer, and the content of the second material of the first layer may be greater than the content of the second material of the second layer.

The first material may have Young’s modulus and shear modulus that are greater than lithium.

The first material may include at least one plate-shaped carbon material selected from the group consisting of graphene, graphene oxide, reduced graphene oxide, graphite, graphite oxide, and combinations thereof.

The second material may include at least one selected from the group consisting of silver (Ag), magnesium (Mg), gold (Au), zinc (Zn), copper (Cu), and combinations thereof.

The first material may have a zeta potential absolute value of 10 mV or greater measured under conditions at pH about 7 and at a temperature of about 25° C.

The second material may have a zeta potential absolute value of about 10 mV or greater measured under conditions at pH about 7 and at a temperature of about 25° C.

The protective layer may include an amount of about 75% by weight to 90% by weight of the first material and an amount of about 10% by weight to 25% by weight of the second material, based on the total weight of the protective layer.

In an aspect, provided is a method for manufacturing an anodeless all-solid-state battery including the steps of preparing a slurry comprising a first material having electrical conductivity, a second material that forms a solid solution with lithium, and a solvent, applying the slurry onto a substrate and vacuum-filtering the slurry, drying a vacuum-filtered product to obtain a protective layer, and obtaining a structure in which an anode current collector, the protective layer, a solid electrolyte layer, and a cathode layer are sequentially laminated.

The solvent may include water.

The second material may have a greater density than the solvent.

The slurry may be prepared by preparing an admixture including the first material, the second material and the solvent and sonicating the admixture to disperse the first material and the second material in the solvent.

The substrate may include a porous membrane, and the slurry may be prepared in a sheet shape by applying the slurry to one surface of the porous membrane and imparting vacuum from the other surface of the porous membrane.

A term “sheet shape” as used herein refers to a three-dimensional shape of a sheet, film or a thin layer, which has a planar surface and a substantially reduced thickness (e.g., micrometer, or nanometer scale) compared to a width or a length of the planar surface.

The porous membrane may have a pore size of about 0.1 µm to 1 µm.

The protective layer may be obtained by drying the vacuum-filtered product under conditions of a vacuum state at a temperature of about 100° C. to 200° C. for about 1 to 24 hours.

Further, provided is a vehicle including the anodeless all-solid-state battery as described herein.

According to various exemplary embodiments of the present disclosure, it is possible to be obtain an anodeless all-solid-state battery including a protective layer having excellent physical properties capable of inhibiting the growth of lithium dendrites, and a method for manufacturing the same.

According to various exemplary embodiments of the present disclosure, it is possible to be obtain an anodeless all-solid-state battery capable of inducing lithium metal to be electrodeposited between a protective layer and an anode current collector, not between a protective layer and a solid electrolyte layer, and a method for manufacturing the same.

According to various exemplary embodiments of the present disclosure, it is possible to obtain an anodeless all-solid-state battery in which a reversible reaction between lithium metal and lithium ions according to charging and discharging can be sustained for a long time, and a method for manufacturing the same.

The effects of the present disclosure are not limited to the above-mentioned effects. It should be understood that the effects of the present disclosure include all effects that can be inferred from the following description.

Other aspects of the invention are disclosed infra.

### BRIEF DESCRIPTION OF THE DRAWINGS

FIG. 1 shows an exemplary anodeless all-solid-state battery according to an exemplary embodiment of the present disclosure.

FIG. 2 shows a state in which the anodeless all-solid-state battery according to an exemplary embodiment of the present disclosure is charged.

FIG. 3 shows an exemplary protective layer according to an exemplary embodiment of the present disclosure.

FIG. 4 is a result of analyzing a cross section of the protective layer with a scanning electron microscope (SEM).

FIG. 5 is a result of analyzing the same cross section as that of FIG. 4 by energy dispersive x-ray spectroscopy (EDS).

FIG. 6 is a result of analyzing the charged state of an anodeless all-solid-state battery according to a Comparative Example with a scanning electron microscope (SEM).

FIG. 7 is a result of analyzing the charged state of an anodeless all-solid-state battery according to an Example with a scanning electron microscope (SEM).

FIG. 8A is a result of measuring the lifespan of the anodeless all-solid-state battery according to the Example.

FIG. 8B is a result of measuring the lifespan of the anodeless all-solid-state battery according to the Comparative Example.

### DETAILED DESCRIPTION

The above objects, other objects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals have been used for similar elements while explaining each drawing. In the accompanying drawings, the dimensions of the structures are illustrated after being enlarged than the actual dimensions for clarity of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” other part, this includes not only the case where it is “directly on” the other part but also the case where there is another part in the middle thereof. Conversely, when a part of a layer, film, region, plate, etc. is said to be “under” other part, this includes not only the case where it is “directly under” the other part, but also the case where there is another part in the middle thereof.

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Further, when a numerical range is disclosed in this description, such a range is continuous, and includes all values from a minimum value of such a range to a maximum value including the maximum value, unless otherwise indicated. Furthermore, when such a range refers to an integer, all integers including from a minimum value to a maximum value including the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

FIG. 1 shows an exemplary anodeless all-solid-state battery according to an exemplary embodiment of the present disclosure. The anodeless all-solid-state battery may be one in which an anode current collector 10, a protective layer 20, a solid electrolyte layer 30, a cathode layer 40, and a cathode current collector 50 are laminated.

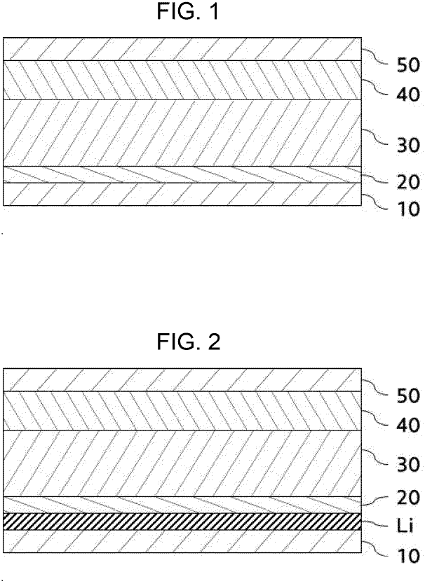

FIG. 2 shows a state in which the anodeless all-solid-state battery according to an exemplary embodiment of the present disclosure is charged. In the anodeless all-solid-state battery, lithium metal (Li) may be precipitated and stored between the protective layer 20 and the anode current collector 10 during charging.

Hereinafter, each configuration of the anodeless all-solid-state battery will be described in detail.

### Cathode Current Collector

The cathode current collector 50 may be a plate-shaped substrate having electrical conductivity. Particularly, the cathode current collector 50 may be formed in the form of a sheet or a thin film.

The cathode current collector 50 may include at least one selected from the group consisting of indium, copper, magnesium, aluminum, stainless steel, iron, and combinations thereof.

### Cathode Layer

The cathode layer 40 is a configuration of reversibly intercalating and deintercalating lithium ions. The cathode layer 40 may contain a cathode active material, a solid electrolyte, a conductive material, a binder, and the like.

The cathode active material may be an oxide active material or a sulfide active material.

Examples of the oxide active material may include rock salt layer-type active materials such as LiCoO₂, LiMnO₂, LiNiO₂, LiVO₂, and Li₁₊ₓNi_{⅓}Co_{⅓}Mn_{⅓}O₂, spinel-type active materials such as LiMn₂O₄ and Li(Ni_{0.5}Mn_{1.5})O₄, inverse spinel-type active materials such as LiNiVO₄ and LiCoVO₄, olivine-type active materials such as LiFePO₄, LiMnPO₄, LiCoPO₄, and LiNiPO₄, silicon-containing active materials such as Li₂FeSiO₄ and Li₂MnSiO₄, rock salt layer-type active materials such as LiNi_{0.8}Co_{(0.2-x)}AlₓO₂ (0<x<0.2) in which a part of the transition metal is substituted with a dissimilar metal, spinel-type active materials such as Li₁₊ₓMn₂₋ₓ₋_{y}M_{y}O₄ (M is at least one of Al, Mg, Co, Fe, Ni, and Zn, and 0 < x+y < 2) in which a part of the transition metal is substituted with a dissimilar metal, and lithium titanates such as Li₄Ti₅O₁₂.

The sulfide active material may include copper chevrel, iron sulfide, cobalt sulfide, nickel sulfide, or the like.

he solid electrolyte may include an oxide-based solid electrolyte or a sulfide-based solid electrolyte. However, it may be preferable to use a sulfide-based solid electrolyte having high lithium ion conductivity. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂—LiₓMO_{y} (provided that x and y are positive numbers, and M is one of P, Si, Ge, B, Al, Ga, and In), Li₁₀GeP₂S₁₂, etc.

The conductive material may be carbon black, conductive graphite, ethylene black, graphene, or the like.

The binder may be butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like.

### Solid Electrolyte Layer

The solid electrolyte layer 30 is a configuration which is positioned between the cathode layer 40 and the anode current collector 10 and responsible for the movement of lithium ions.

The solid electrolyte layer 30 may contain a solid electrolyte having lithium ion conductivity.

The solid electrolyte may include an oxide-based solid electrolyte or a sulfide-based solid electrolyte. However, it may be preferable to use a sulfide-based solid electrolyte having high lithium ion conductivity. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂—LiₓMO_{y} (provided that x and y are positive numbers, and M is one of P, Si, Ge, B, Al, Ga, and In), Li₁₀GeP₂S₁₂, etc. The solid electrolyte contained in the solid electrolyte layer 30 may be the same as or different from that contained in the cathode layer 40.

The solid electrolyte layer 30 may further include a binder. The binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like. The binder contained in the solid electrolyte layer 30 may be the same as or different from that contained in the cathode layer 40.

### Anode Current Collector

The anode current collector 10 may be a plate-shaped substrate having electrical conductivity. Particularly, the anode current collector 10 may be formed in the form of a sheet or a thin film.

The anode current collector 10 may include a material that does not react with lithium. Specifically, the anode current collector 10 may include at least one selected from the group consisting of nickel, stainless steel, titanium, cobalt, iron, and combinations thereof.

### Protective Layer

The protective layer 20 may be positioned between the anode current collector 10 and the solid electrolyte layer 30, and suppress the growth of lithium dendrites and allow lithium ions to move between both configurations.

The protective layer 20 may include a first material that has electrical conductivity and a second material that forms a solid solution with lithium.

Since the first material has electrical conductivity, it is responsible for the movement of electrons required for charging and discharging the battery within the protective layer 20.

Further, the first material may have excellent physical properties enough to suppress the growth of lithium dendrites. Particularly, the first material may have higher Young’s modulus and shear modulus than lithium. For example, the first material may have a Young’s modulus of 400 GPa to 900 GPa and a shear modulus of 200 GPa to 500 GPa.

The first material may include at least one plate-shaped carbon material selected from the group consisting of graphene, graphene oxide, reduced graphene oxide, graphite, graphite oxide, and combinations thereof.

The second material forms a solid solution with lithium ions and allows the lithium ions to pass through the protective layer 30. Here, forming a solid solution means that the second material and lithium form a uniform single phase. Particularly, it means that the second material and lithium occupy specific atomic sites to form a specific crystal structure. In this case, the ratio of the second material to lithium is not particularly limited, but the ratio of lithium may be preferably larger than that of the second material.

The second material may not have reactivity with the first material. This is because, if a side reaction with the first material occurs, the side reaction may adversely affect the performance of the battery.

The second material may include at least one selected from the group consisting of silver (Ag), magnesium (Mg), gold (Au), zinc (Zn), copper (Cu), and combinations thereof.

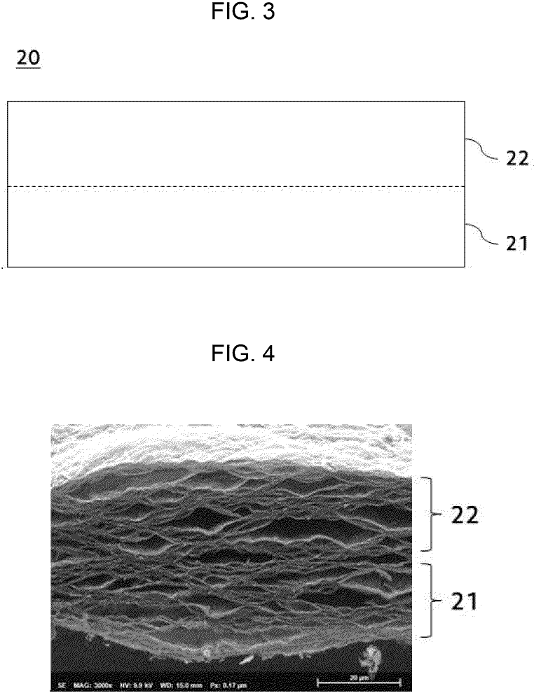

FIG. 3 shows the protective layer 20 according to an exemplary embodiment of the present disclosure. The protective layer 20 shown in FIG. 3 is shown in the same orientation as in FIGS. 1 and 2. The solid electrolyte layer 30 is positioned above the protective layer 20 based on FIG. 3, and the anode current collector 10 is positioned below the protective layer 20 based on FIG. 3.

The protective layer 20 may include a first layer 21 on the side of the anode current collector 10 and a second layer 22 on the side of the solid electrolyte layer 30. The first layer 21 and the second layer 22 are not separated by a physical interface, and the protective layer 20 may be conceptually divided. The thicknesses of the first layer 21 and the second layer 22 are not particularly limited, and for example, the ratio (t₁/t₂) of a thickness t₁ of the first layer 21 to a thickness t₂ of the second layer 22 may be 0.5 to 2.

The protective layer 20 is characterized in that the content of the second material of the first layer 21 is higher than that of the second material of the second layer 22. The first layer 21 close to the side of the anode current collector 10 may contain a greater amount of the second material. This is to allow lithium ions to be precipitated and stored between the protective layer 20 and the anode current collector 10. For example, when the second material is evenly distributed in the protective layer 20, when the concentration of the second material forming a solid solution exceeds a critical point, lithium metal (Li) may be precipitated and stored even at the interface between the protective layer 20 and the solid electrolyte layer 30. On the other hand, when the second material is mainly present in the first layer 21 as in the present disclosure, lithium metal (Li) is dominantly precipitated and stored between the protective layer 20 and the anode current collector 10.

The first material and the second material have different concentration distributions in the thickness direction within the protective layer 20, but the first material and second material need to be evenly distributed in the plane direction. For example, when the first material and/or the second material are concentrated at a specific point in the plane direction, lithium metal may be precipitated at that point so that lithium dendrites are grown. Therefore, the dispersibility of the first material and the second material is very important, which can be specified as the zeta potential of the first material and the second material. Particularly, each of the zeta potential absolute values of the first material and the second material measured under conditions at pH about 7 and at a temperature of about 25° C. may be about 10 mV or greater, about 20 mV or greater, or about 30 mV.

The protective layer 20 may include an amount of about 75% by weight to 90% by weight of the first material and an amount of about 10% by weight to 25% by weight of the second material. When the content of the second material is less than about 10% by weight, the movement of lithium ions within the protective layer 20 may not be smooth. When it is greater than about 25% by weight, the amount of lithium ions that form a solid solution with the second material within the protective layer 20 is rather increased so that it may be difficult for lithium metal (Li) to be electrodeposited between the protective layer 20 and the anode current collector 10.

Hereinafter, a method for manufacturing an anodeless all-solid-state battery according to the present disclosure will be described in detail.

The manufacturing method may comprise the steps of: preparing a slurry comprising a first material having electrical conductivity, a second material that forms a solid solution with lithium, and a solvent; applying the slurry onto a substrate and vacuum-filtering the slurry; drying a vacuum-filtered product to obtain a protective layer; and obtaining a structure in which an anode current collector, the protective layer, a solid electrolyte layer, and a cathode layer are sequentially laminated.

The solvent is not particularly limited, but may include an aqueous solvent such as water.

The slurry may be prepared by preparing an admixture including a first material, a second material and a solvent component, and then evenly dispersing the first material and the second material in the solvent by sonicating the admixture.

The introduction order of the first material and the second material is not particularly limited, and for example, the first material and the second material may be simultaneously introduced, or the first material may be introduced first and then the second material may be introduced.

Conditions for sonicating or irradiating the first material and the second material with the ultrasonic waves are not particularly limited, and the first material and second material may be irradiated with the ultrasonic waves with the degree of an intensity that does not affect the first material and second material.

The slurry may be applied onto a substrate and vacuum filtered to vary the distribution of the second material in the thickness direction of the protective layer as described above. A porous membrane may be preferably used as the substrate, and the slurry may be applied onto one surface of the porous membrane. Thereafter, vacuum may be imparted to the other surface of the porous membrane to allow the slurry to form a series of layers in a sheet shape. At this time, since the second material has a greater density than the solvent component and/or the first material, the second material moves much toward the porous membrane during vacuum filtration.

As the porous membrane, a porous membrane having a pore size of about 0.1 µm to 1 µm, or about 0.2 µm to 0.45 µm may be used.

Thereafter, the above-described protective layer may be obtained by drying the vacuum-filtered product under conditions of a vacuum state at a temperature of about 100° C. to 200° C. for about 1 hour to 24 hours.

Thereafter, an anodeless all-solid-state battery may be obtained by forming a structure in which the anode current collector 10, the protective layer 20, the solid electrolyte layer 30, the cathode layer 40, and the cathode current collector 50 are sequentially laminated.

### EXAMPLE

Hereinafter, another embodiment of the present disclosure will be described in more detail through Examples. The following Examples are merely illustrative to help the understanding of the present disclosure, and the scope of the present disclosure is not limited thereto.

### Example

A slurry was prepared by adding graphene oxide as a first material and silver nanoparticles as a second material to water as a solvent at a ratio of 75:25. The first material was added to water at a concentration of 2.5 mg/ml. Thereafter, the second material was introduced at the above ratio, and was irradiated with ultrasonic waves for about 30 minutes so that the first material and the second material were evenly dispersed.

The slurry was applied onto a porous membrane and vacuum filtered.

The vacuum-filtered product was separated from the porous membrane, and dried in a vacuum state at a temperature of about 180° C. for about 24 hours to form a protective layer.

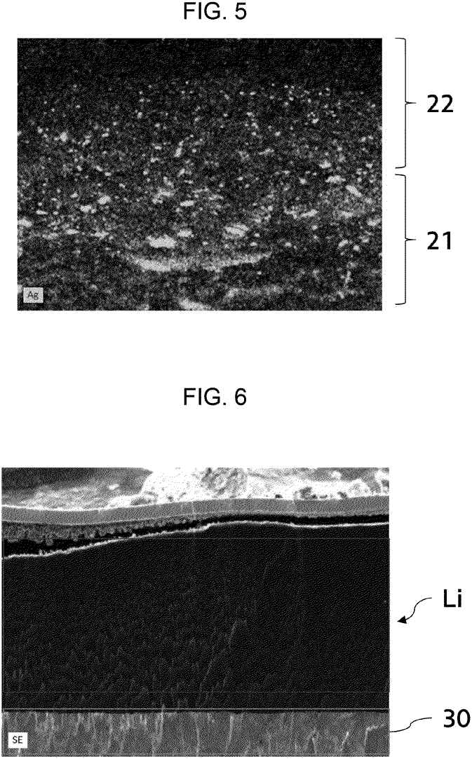

FIG. 4 shows a cross section of an exemplary protective layer with a scanning electron microscope (SEM). FIG. 5 shows the same cross section by energy dispersive x-ray spectroscopy (EDS).

As shown in FIGS. 4 and 5, a greater amount of the second material having a high density by forming the protective layer through vacuum filtration is present in the first layer 21 than in the second layer 22. Therefore, in the anodeless all-solid-state battery according to an exemplary embodiment of the present disclosure, lithium metal (Li) can be induced to be precipitated and stored between the protective layer 20 and the anode current collector 10.

Thereafter, an anodeless all-solid-state battery according to the exemplary embodiments of the present disclosure was obtained by sequentially laminating the anode current collector, the protective layer, the solid electrolyte layer, the cathode layer, and the cathode current collector.

### Comparative Example

An anodeless all-solid-state battery was manufactured by using the same materials as in the Example, except that an anode current collector, a solid electrolyte layer, a cathode layer, and a cathode current collector were sequentially laminated without a protective layer.

### Experimental Example

The anodeless all-solid-state batteries according to the Example and Comparative Example were charged and discharged under the same conditions.

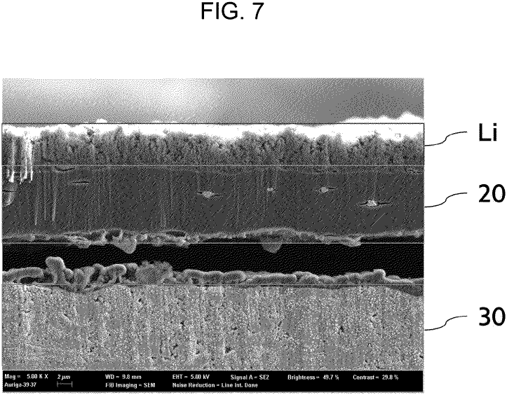

FIG. 6 is a result of analyzing the charged state of the anodeless all-solid-state battery according to the Comparative Example with a scanning electron microscope (SEM). FIG. 7 is a result of analyzing the charged state of the anodeless all-solid-state battery according to the Example with a scanning electron microscope (SEM).

As shown in FIG. 6, lithium metal (Li) was in direct contact with the solid electrolyte layer 30 in the anodeless all-solid-state battery according to the Comparative Example without a protective layer.

As shown in FIG. 7, lithium metal (Li) was electrodeposited on the protective layer 20, not between the protective layer 20 and the solid electrolyte layer 30, in the anodeless all-solid-state battery according to the Example comprising the protective layer 20.

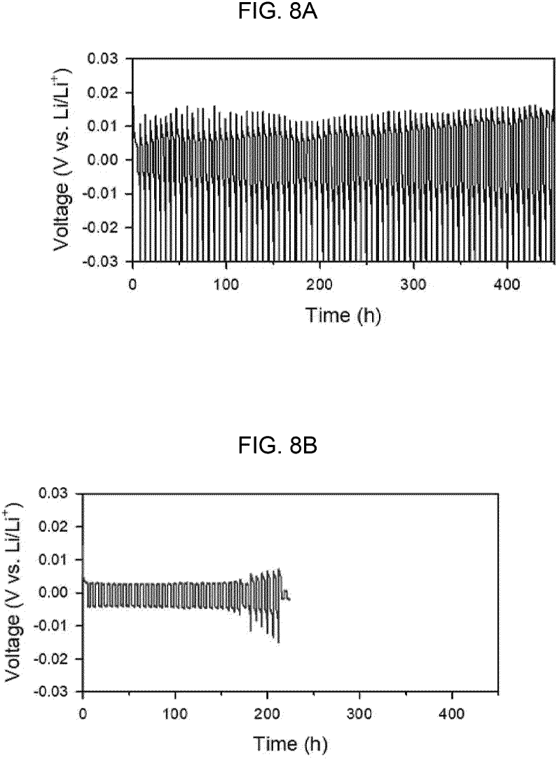

FIG. 8A is a result of measuring the lifespan of the anodeless all-solid-state battery according to the Example. FIG. 8B is a result of measuring the lifespan of the anodeless all-solid-state battery according to the Comparative Example. As shown in FIGS. 8A and 8B, an internal short circuit occurs within a short time when lithium metal (Li) was in direct contact with the solid electrolyte layer 30 as in the Comparative Example, whereas the anodeless all-solid-state battery including the protective layer 20 as in the Example was charged and discharged well without occurrence of a short circuit.

As the Experimental Example and Examples of the present disclosure have been described in detail above, the right scope of the present disclosure is not limited to the above-described Experimental Example and Examples, and various modifications and improved forms made by those skilled in the art using the basic concept of the present disclosure as defined in the following claims are also included in the right scope of the present disclosure.

### Explanation of Marks

10: Anode current collector
20: Protective layer
30: Solid electrolyte layer
40: Cathode layer
50: Cathode current collector
21: First layer
22: Second layer

What is claimed is:

1. An anodeless all-solid-state battery comprising:
an anode current collector;
a protective layer disposed on the anode current collector;
a solid electrolyte layer disposed on the protective layer; and
a cathode layer disposed on the solid electrolyte layer,
wherein the protective layer comprises a first material having electrical conductivity; and a second material that forms a solid solution with lithium,
the protective layer comprises a first layer on the side of the anode current collector; and a second layer on the side of the solid electrolyte layer, and
the content of the second material of the first layer is greater than the content of the second material of the second layer.

2. The anodeless all-solid-state battery of claim 1, wherein the first material has Young’s modulus and shear modulus greater than those of lithium.

3. The anodeless all-solid-state battery of claim 1, wherein the first material comprises at least one plate-shaped carbon material selected from the group consisting of graphene, graphene oxide, reduced graphene oxide, graphite, graphite oxide, and combinations thereof.

4. The anodeless all-solid-state battery of claim 1, wherein the second material comprises at least one selected from the group consisting of silver (Ag), magnesium (Mg), gold (Au), zinc (Zn), copper (Cu), and combinations thereof.

5. The anodeless all-solid-state battery of claim 1, wherein the first material has an absolute value of a zeta potential of 10 mV or greater measured under conditions of pH about 7 and at a temperature of about 25° C.

6. The anodeless all-solid-state battery of claim 1, wherein the second material has an absolute value of a zeta potential of 10 mV or greater measured under conditions of pH about 7 and at a temperature of about 25° C.

7. The anodeless all-solid-state battery of claim 1, wherein the protective layer comprises an amount of about 75% by weight to 90% by weight of the first material and an amount of about 10% by weight to 25% by weight of the second material, based on the total weight of the protective layer.

8. A method for manufacturing an anodeless all-solid-state battery, comprising the steps of:
preparing a slurry comprising a first material having electrical conductivity, a second material that forms a solid solution with lithium, and a solvent component;
applying the slurry onto a substrate and vacuum-filtering the slurry;
drying a vacuum-filtered product to obtain a protective layer; and
obtaining a structure in which an anode current collector, the protective layer, a solid electrolyte layer, and a cathode layer are sequentially laminated,
wherein the protective layer comprises a first layer on the side of the anode current collector; and a second layer on the side of the solid electrolyte layer, and
the content of the second material of the first layer is greater than the content of the second material of the second layer.

9. The method of claim 8, wherein the solvent comprises water.

10. The method of claim 8, wherein the first material has Young’s modulus and shear modulus greater than those of lithium.

11. The method of claim 8, wherein the first material comprises at least one plate-shaped carbon material selected from the group consisting of graphene, graphene oxide, reduced graphene oxide, graphite, graphite oxide, and combinations thereof.

12. The method of claim 8, wherein the second material has a density greater than that of the solvent.

13. The method of claim 8, wherein the second material comprises at least one selected from the group consisting of silver (Ag), magnesium (Mg), gold (Au), zinc (Zn), copper (Cu), and combinations thereof.

14. The method of claim 8, wherein the first material has an absolute value of a zeta potential of 10 mV or more measured under conditions at pH about 7 and at a temperature of about 25° C.

15. The method of claim 8, wherein the second material has an absolute value of a zeta potential of 10 mV or more measured under conditions at pH about 7 and at a temperature of about 25° C.

16. The method of claim 8, wherein the protective layer comprises an amount of about 75% by weight to 90% by weight of the first material and an amount of about 10% by weight to 25% by weight of the second material, based on the total weight of the protective layer.

17. The method of claim 8, wherein the slurry is prepared by preparing an admixture comprising the first material, the second material and the solvent and sonicating the admixture to disperse the first material and the second material in the solvent.

18. The method of claim 8, wherein the substrate comprises a porous membrane, and the slurry is prepared in a sheet shape by applying the slurry to one surface of the porous membrane and imparting vacuum to the other surface of the porous membrane.

19. The method of claim 8, wherein the porous membrane has a pore size of about 0.1 µm to 1 µm.

20. The method of claim 8, wherein the protective layer is obtained by drying the vacuum-filtered product under conditions of a vacuum state at a temperature of about 100° C. to 200° C. for about 1 to 24 hours.
